(19) United States
(12) Patent Application Publication
(10) Pub. No.: US 2006/0212792 A1
(43) Pub. Date: Sep. 21, 2006

(54) Synchronously publishing a web page and corresponding web page resources

(75) Inventors: Christopher Edward White, Seattle, WA (US); George Perantatos, Seattle, WA (US); William J. Griffin, Sammamish, WA (US); Boxin Li, Bellevue, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/083,480

(22) Filed: Mar. 18, 2005

(51) Int. Cl. G06F 17/00; G06F 17/30

(52) U.S. Cl. 715/511; 715/501.1; 715/530; 707/200

(57) ABSTRACT

Methods and system provide for synchronously publishing a web page and its corresponding resources. Images, documents, files, and pages may be bound or tied to a parent web page which allows these resources to follow the parent web page lead as to whether or not they may be browsed, whether or not they may be moved, deleted, or renamed, whether edits made to these resources are published, or whether changes are undone or reverted to a prior version. Metadata associated with such resources may be sourced by a parent web page for maintaining up-to-date corresponding data in the parent web page. A reference for a given resource may be placed in a corresponding web page region for impersonating the actual target resource item and allows for automatically expiring references to items when an associated target resource item expires, automatically repairing link addresses on a parent web page when a target resource item is moved, and allows for representing the security of a target resource item in the parent web page so that only those with rights and privileges to view the target resource item may access the target resource item via the web page.

### FIELD OF THE INVENTION

The present invention generally relates to association of web page resources and data with web page presentation. More particularly, the present invention relates to synchronously publishing a web page and corresponding web page resources.

### BACKGROUND OF THE INVENTION

With the advent of the computer age, computer and software users have grown accustomed to user-friendly software applications that help them write, calculate, organize, prepare presentations, send and receive electronic mail, make music, and the like. For example, modem electronic word processing applications allow users to prepare a variety of useful documents. Modem spreadsheet applications allow users to enter, manipulate, and organize data. Modem electronic slide presentation applications allow users to create a variety of slide presentations containing text, pictures, data or other useful objects. Internet and intranet browsing applications allow users to navigate to a variety of useful pages for viewing or interacting with information on numerous topics.

Typical Internet web pages often include information such as text, images, music and the like associated with one or more topics. In addition, many web pages include links to various resources either contained on the same web page as a given link or contained on a different web page. Selection of a given link causes the user's web browsing application to locate and display or otherwise execute the resource associated with the selected link. Images, links to documents and files, as well as links to other pages, are all presented in one screen in a user's web browsing application. And, the web page often retrieves these various forms of information from multiple logical locations on a web server.

When a web page comprised of these remote elements is published and is accessible by web browsing applications, the web page becomes dependent upon these resources. If the resources are deleted, moved, altered, taken offline for editing, or otherwise made unavailable or inaccessible by the web page, the web page will suffer either by rendering broken links or broken image and/or text regions on the page.

Accordingly, there is a need for methods and systems for improving association of web page resources and data with web page presentation. There is further a need for synchronously publishing a web page and its corresponding resources. It is with respect to these and under considerations that the present invention has been made.

### SUMMARY OF THE INVENTION

Embodiments of the present invention solve the above and other problems by providing improved maintenance of the association of web page resources with corresponding regions and links in a web page. According to one embodiment of the present invention, resources such as images, documents, files and other web pages and associated resources, are tied to or bound to a parent web page. When the parent web page is published or made available for access by browsing applications, all dependent items are also published. When the web page is unpublished or made unavailable for access by browsing applications, then all dependent items are also unpublished. When a page is reverted to a prior published version, then all dependent items are also reverted to a prior published version that matches the version presented in the parent web page at the prior time. When the parent page is deployed or copied from an authoring web server or web server cluster to a production web server or web server cluster, where web pages on the production server are accessible by a larger audience, all dependent items are also deployed or copied to the production web server or web server cluster. Dependent items may be “locked” for use by the parent web page. This prevents the dependent items from being moved, deleted, or edited outside of the authoring of the parent page.

According to another embodiment, metadata associated with dependent resources or items that are associated with or linked to regions or links of a given web page are sourced as they are added to a parent web page. Thus, the metadata may be pulled directly into the appropriate region or link in the web page from the sourced dependent resource or item. Rather than a web page author having to type in a title, description, image or other data presented as the link or image on the web page, the author may optionally source the metadata of the target item on the parent page. According to one aspect of this embodiment, the author picks and chooses the metadata she wants from the target and uses it on her web page, and the author annotates her own metadata for excluding metadata the author does not want from the source item.

According to another embodiment, resources associated with or linked to regions or links of a web page are “impersonated” in the web page by placing a reference to each resource in the web page so that the reference behaves as if it is the actual target resource. Impersonating the reference in the web page by placing the reference to the resource in the web page provides for security of the target item, such as when a browsing party does not have rights to the target item. Placing the reference to the resource in the web page also provides for hiding target information associated with the reference from the web page if the target information has expired. Further, if a URL for the target information has changed, providing a reference to a target resource in the web page allows for automatic updating of the new URL to prevent link breakage.

These and other features and advantages, which characterize the present invention, will be apparent from a reading of the following detailed description and a review of the associated drawings. It is to be understood that both the foregoing general description and the following detailed description are exemplary and explanatory only and are not restrictive of the invention as claimed.

### BRIEF DESCRIPTION OF THE DRAWINGS

FIG. 1 is a block diagram showing the architecture of a personal computer that provides an illustrative operating environment for embodiments of the present invention.

FIG. 2 illustrates a computer screen display of an Internet-based or intranet-based web page showing a variety of images, text, and links associated with remote references according to embodiments of the present invention.

FIG. 3 illustrates a computer screen display of an Internet-based or intranet-based web page showing the tying of remote resources to regions or links in a web page according to embodiments of the present invention.

FIG. 4 illustrates a computer screen display of an Internet-based or intranet-based web page illustrating the sourcing of metadata associated with a target resource referenced in a given web page.

### DETAILED DESCRIPTION

As briefly described above, embodiments of the present invention are directed to methods and systems for improving maintenance of the association of web page resources with corresponding regions and links in a web page. According to embodiments of the present invention, a model for creating dependencies between items in a web page and associated target resources is provided. Metadata associated with dependent items or resources associated with regions and/or links in a parent web page may be sourced by the parent web page. Additionally, embodiments of the present invention provide for placing a reference in a parent web page associated with a target resource for providing improved security of access to the target resource, maintenance of presentation of the target resource, and update of uniform resource locator (URL) information associated with target references.

These embodiments may be combined, other embodiments may be utilized, and structural changes may be made without departing from the spirit or scope of the present invention. The following detailed description is therefore not to be taken in a limiting sense and the scope of the present invention is defined by the appended claims and their equivalents.

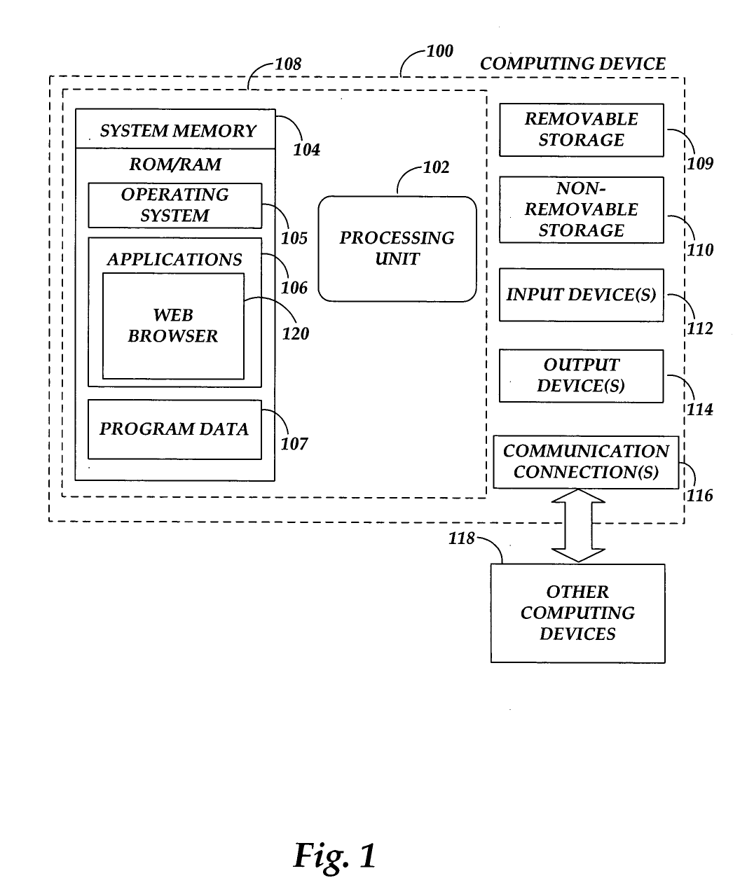

Referring now to the drawings, in which like numerals refer to like elements through the several figures, aspects of the present invention and an exemplary operating environment will be described. FIG. 1 and the following discussion are intended to provide a brief, general description of a suitable computing environment in which the invention may be implemented. While the invention will be described in the general context of program modules that execute in conjunction with an application program that runs on an operating system on a personal computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Embodiments of the invention may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

With reference to FIG. 1, one exemplary system for implementing the invention includes a computing device, such as computing device 100. In a basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes an operating system 105, one or more applications 106, and may include program data 107. In one embodiment, application 106 may include a web browsing application 120, such as INTERNET EXPLORER®, manufactured by MICROSOFT CORPORATION. This basic configuration is illustrated in FIG. 1 by those components within dashed line 108.

The computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data. System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as keyboard, mouse, pen, voice input device, touch input device, etc. Output device(s) 114 such as a display, speakers, printer, etc. may also be included. These devices are well know in the art and need not be discussed at length here.

Computing device 100 may also contain communication connections 116 that allow the device to communicate with other computing devices 118, such as over a network in a distributed computing environment, for example, an intranet or the Internet. Communication connection 116 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

A number of program modules and data files may be stored in the system memory 104 of the computing device 100, including an operating system 105 suitable for controlling the operation of a networked personal computer, such as the WINDOWS operating systems from MICROSOFT CORPORATION of Redmond, Wash. System memory 104 may also store one or more program modules, such as word processor application 120, and others described below. The web browsing application 120 is operative to provide functionality for viewing, editing, and processing electronic information via one or more Internet-based or other network-based web pages. In addition, as described herein, web page content is edited in a web page editing mode. Web page editing may be performed via an editing mode of the web browsing application 120, or via another suitable web page editing application or tool may be programmed for allowing editing of a web page via a drag and drop operation described herein. Other applications 106 that may be used in accordance with embodiments of the present invention include electronic mail and contacts applications, word processing applications, spreadsheet applications, database applications, slide presentation applications, drawing or computer-aided application programs, etc.

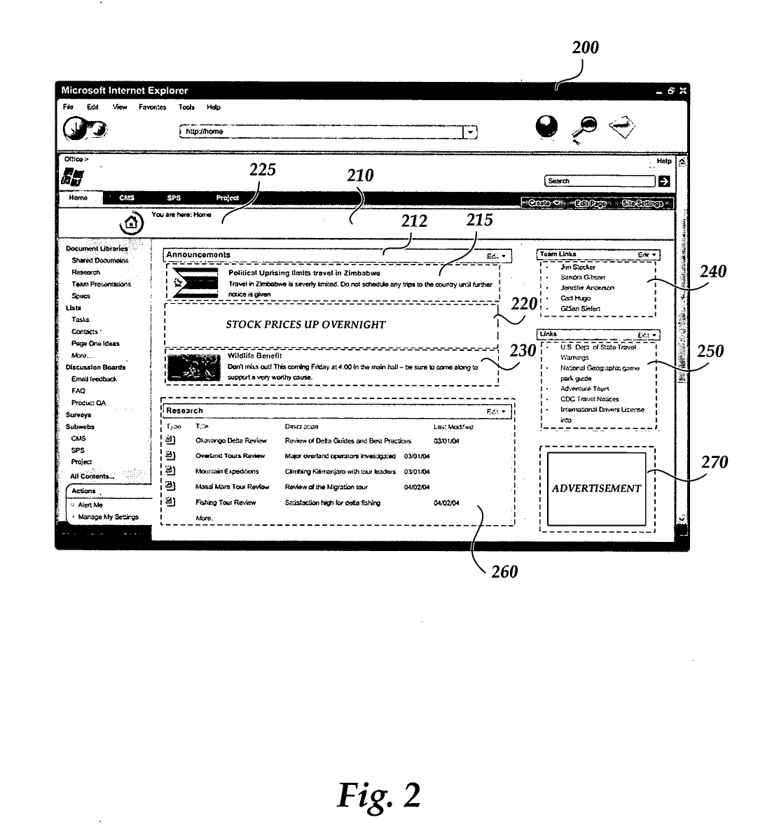

FIG. 2 illustrates a computer screen display of an Internet-based or intranet-based web page showing a variety of images, text, and links associated with remote references according to embodiments of the present invention. The example web page 200 includes a variety of images, links to documents and files as well as links to other web pages. Regions illustrated in the web page 200 that are outlined in dashed lines reference other items such as documents, images, or links to other pages or sites. For example, the item 225 references an image being displayed in a title section of 210 of the web page 200. The regions 215, 220, 230 reference documents or files used for populating the regions 215, 220, 230 with helpful information such as news information. The region 240 provides a variety of links for linking the web page 200 to other web pages or other resources that may be accessed by selecting one of the provided links. Each of these outlined regions represents a dependency for the web page 200 that, if changed, ultimately changes the web page 200. That is, for any of these outlined regions that are dependent upon a remote resource, if the resource is deleted, moved, altered and then made public for users to browse, taken offline for editing, or is otherwise made unavailable to the web page, the web page presentation and performance will be harmed either by rendering broken links or broken image and/or text regions in the web page. For example, if a given region in the web page is populated with information from a remote resource document that becomes unavailable, a blank space may appear in the web page. Additionally, in some cases, a web page renders in a satisfactory manner, but regions of the page change without the author's control because dependent resources are altered and published thereby causing the presentation of those dependent resources on the page to change without any approval by the parent page author.

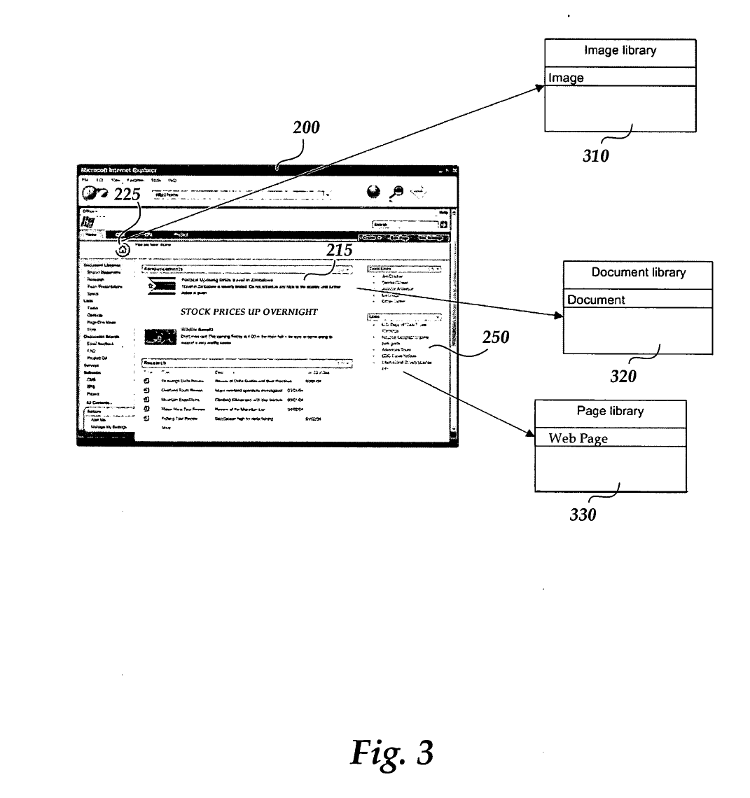

Referring to FIG. 3, according to embodiments of the present invention, the web page 200 and each of its dependent resources are tied together for creating dependencies between items in the page and each of the respective dependent resources. For example, as illustrated in FIG. 3, a dependency is created between an image library 310 containing an image that is displayed as image 225 in the web page 200. Similarly, a document resource at a document library 320 is tied to a region 215 in the web page 200 for providing a dependency between a document in the document library 320 and the corresponding region in the web page 200. Similarly, a page library 330 is provided for associating a linked web page with a region 250 in the parent web page 200. Thus, a dependency is created between the page library 330 and the region 250 of the web page 200. According to embodiments of the present invention, when an item is added to a web page, for example, the region 220 of the web page 200, illustrated in FIG. 2, a dependency is tracked between the source page (parent web page) and a target item (resource) from which information is obtained for populating the associated region in the web page 200.

According to embodiments of the present invention, by creating dependencies between resource items and associated regions or links in the associated web page 200, when the web page 200 is published or made available for access by a browsing application, then all dependent items are also published. Thus, during the publication period, if a given dependent item (resource) is altered or otherwise affected, the presently published version of the parent web page remains in tact with all resource information “as published” when the parent web page was published. A page author can control whether these changes are allowed or not. Typically, if your page is associated with dependent resources, the page author will not want to allow anyone to alter those dependent resources. When the parent page is deployed or copied from an authoring web server or web server cluster to a production web server or web server cluster, where web pages on the production server are accessible by a larger audience, all dependent items are also deployed or copied to the production web server or web server cluster. Similarly, when the web page is unpublished or is made unavailable for access by a browsing application then all dependent items are also unpublished. Each published version of the parent web page and published dependent resources are stored in “as published” versions. Thus, when a web page 200 is reverted to a prior published version, then all dependent items are also reverted to a prior published version that matches the version presented in the parent page at the prior time.

According to one embodiment of the present invention, dependent items such as the image contained in the image library 310, the document contained in the document library 320, and the web page contained in the page library 330 may be locked by the parent web page 200 author/editor once they are tied to regions or links in the parent web page. Locking the dependent items prevents the dependent items from being moved, deleted, or edited outside the authoring of the parent web page 200. Thus, locking the dependent items or resources requires that edits to any of the locked items or resources must be made through edits to the web page 200.

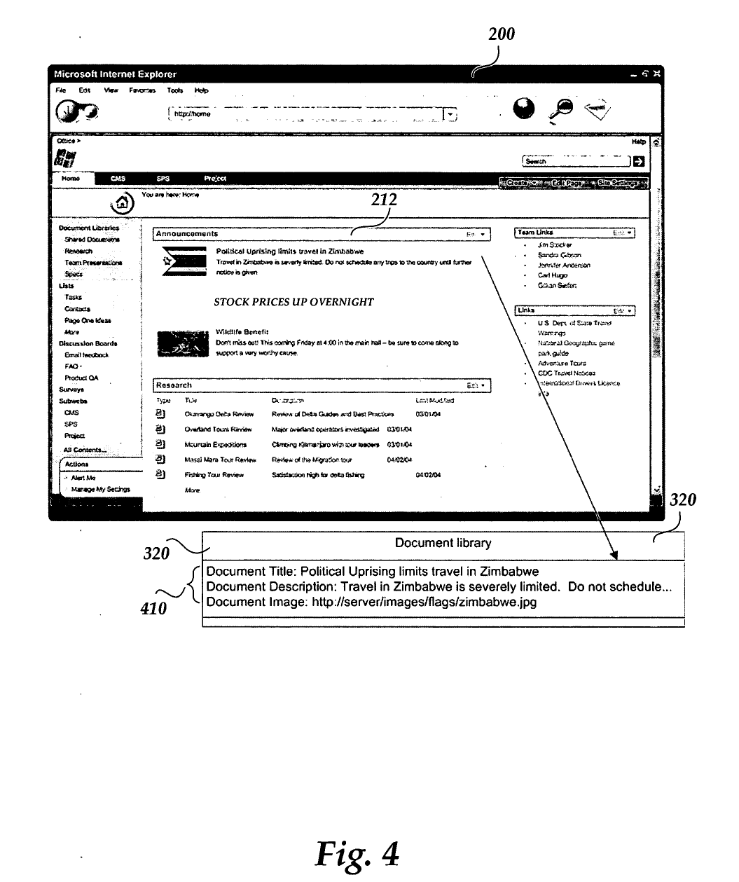

Referring now to FIG. 4, according to another embodiment of the present invention, metadata associated with a dependent item or resource is sourced by the web page 200. Thus, the metadata may be pulled directly into the appropriate region or link in the web page from the sourced dependent resource or item. That is, rather than requiring a web page author/editor to type a title, description, image or other data into a link or region of a web page, according to this embodiment, the web page author/editor may source such metadata from the resource onto the web page. As illustrated in FIG. 4, a resource 320, for example a document library includes metadata associated with an article linked to a region 215 of the web page 200. Metadata 410 from the document library 320 includes a document title, a document description, and a document image for display in the region 215. According to this embodiment of the present invention, the metadata from the resource associated with the region in the web page is sourced by the web page so that information is utilized for populating the associated web page region. Accordingly, if the target resource metadata is changed, the change in the metadata will be automatically reflected in the associated web page region 215. For example, if the document title is changed to a different title, then the title populated in the region 215 in the web page 200 is automatically changed without requiring manual edits to the region 215 in the web page 200. The web page author may choose what metadata to source and what metadata to annotate. In the example web page illustrated in FIG. 4, the author may choose to leave the document image alone, but change the document title so that the document title is a better fit for the web page.

According to another embodiment of the present invention, resources associated with or linked to regions of a web page are “impersonated” in the web page by placing a reference to each resource in the web page so that the reference behaves as if it is the actual target resource. According to this embodiment of the present invention, a model is provided for placing a reference to a file, page, link, image, and the like on the web page 200 and having that reference impersonate the actual remotely stored resource item. Each referenced resource is monitored to track the continued availability of the reference or changes associated with the resource, such as changes to the resource's URL because of a change in location of the resource. Such “impersonation” behavior by the reference placed in the web page allows for preventing selection of the reference for access to a corresponding resource if the resource is not available. Thus, confusion to users is avoided because the availability of the reference in the web page signals an availability of the actual target resource. If the reference is not published, or is otherwise hidden from view, the user will not select the reference only to be thwarted by a lack of availability or access to the actual resource.

For example, the reference may be hidden from the web page based on security associated with the actual target resource item. That is, if a user browsing to the web page does not have rights for accessing and reviewing the actual target resource item, the user will not see the reference in the web page. If the user does have rights to the resource, then the reference will be visible to the user, and the user may select the reference for accessing the desired resource. For another example, the reference to the actual resource may be hidden in the web page based on expiration of the associated actual target resource. If the target resource is set to expire on a certain day/time, once that day/time is reached, the reference to the actual target resource item on the web page disappears.

Additionally, the reference to the actual target resource item may receive an updated URL based on movement of the actual target resource item. For example, if the target resource item is moved from one location to a second location, all web pages referencing that resource item will automatically be updated to use the new URL. Accordingly, no links to these references will be broken based on movement of the target resource item. This will not only work for references from within a local site, but also for references across sites in a distributed computing environment.

As described herein, a method and system for synchronously publishing a web page and its corresponding resources is provided. According to embodiments of the present invention, images, documents, files, and pages may be bound or tied to a parent web page which allows these resources to follow the parent web page lead as to whether or not they may be browsed, whether or not they may be moved, deleted, or renamed, whether edits made to these resources are published, or whether changes are undone or reverted to a prior version. In addition, according to embodiments of the present invention, metadata associated with such resources may be sourced by a parent web page for maintaining up-to-date corresponding data in the parent web page. And, as described above, placing a reference in a given web page for impersonating an actual target resource item allows for automatically expiring references to items when an associated target resource item expires, automatically repairing link addresses on a parent web page when a target resource item is moved, and allows for representing the security of a target resource item in the parent web page so that only those with rights and privileges to view the target resource item may access the target resource item via the web page.

It will be apparent to those skilled in the art that various modifications or variations may be made in the present invention without departing from the scope or spirit of the invention. Other embodiments of the invention will be apparent to those skilled in the art from consideration of the specification and practice of the invention disclosed herein.

We claim:

1. A computer-readable medium on which is stored computer-executable instructions which when executed by a computer perform a method of associating web resources with corresponding web page items; comprising:
identifying one or more web page resources for supplying information to one or more respective web page items;
binding a given web page item to a corresponding web page resource; and
if a web page containing the given web page item is published for access by a web browsing application, automatically publishing with the web page any information from the corresponding web page resource required by the corresponding given web page item.

2. The computer-readable medium of claim 1, while the web page is published, if information from the corresponding resource is altered or made unavailable at a source location for the corresponding web page resource, maintaining the publication of the information from the corresponding web page resource that was available prior to the alteration or unavailability of the resource.

3. The computer-readable medium of claim 2, further comprising:
storing the publication of the web page along with corresponding published web page information from the corresponding web page resource required by the corresponding given web page item; and
if a previous publication version of the web page is republished, publishing a stored previous publication version of the web page along with a stored version of any correspondingly published information from any of the one or more web page resources.

4. The computer-readable medium of claim 1, in response to binding a given web page item to a corresponding web page resource, locking the corresponding web page resource from subsequent access by a user other than an author of the web page.

5. The computer-readable medium of claim 4, allowing access to the locked corresponding web page resource via the web page.

6. The computer-readable medium of claim 1, further comprising:
sourcing data from a given web page resource to a corresponding web page item; and
populating the corresponding web page item with data sourced from the given web page resource.

7. The computer-readable medium of claim 6, whereby if data in the given web page resource is updated, automatically updating the data populated in the corresponding web page item.

8. The computer-readable medium of claim 1, further comprising placing a reference in the web page corresponding to a given web page resource.

9. The computer-readable medium of claim 8, whereby if browsing to a data item from the given web page resource is not available, hiding the reference from view in the web page to prevent attempted access to the corresponding given web page resource.

10. The computer-readable medium of claim 9, further comprising hiding the reference from view in the web page to prevent attempted access to the corresponding given web page resource if a user attempting to browse to the given web page resource does not have access privileges to the given web page resource.

11. The computer-readable medium of claim 8, whereby if access to the corresponding given web page resource expires, removing the reference from the web page corresponding to the expired web page resource.

12. The computer-readable medium of claim 8, whereby if a uniform resource locator (URL) for a given web page resource is updated, automatically updating a corresponding URL for the reference to allow access to the given web page resource via the reference placed in the web page corresponding to the given web page resource.

13. A method of associating web resources with corresponding web page items; comprising:
identifying one or more web page resources for supplying information to one or more respective web page items;
binding a given web page item to a corresponding web page resource;
if a web page containing the given web page item is published for access by a web browsing application, automatically publishing with the web page information from the corresponding web page resource required by the corresponding given web page item; and
if information from the corresponding web page resource is altered or made unavailable at a source location for the corresponding web page resource, continuing to publish the web page and the web page information from the corresponding web page resource as the web page information was published prior to any alteration or unavailability of the information from the corresponding web page resource.

14. The method of claim 13, further comprising:
storing the publication of the web page along with corresponding published web page information from the corresponding web page resource; and
if a previous publication version of the web page is republished, publishing a stored previous publication version of the web page along with a stored version of any correspondingly published information from any of the one or more web page resources.

15. The method of claim 13, in response to binding a given web page item to a corresponding web page resource, locking the corresponding web page resource from subsequent access; and allowing access to the locked corresponding web page resource via the web page.

16. The method of claim 13, further comprising:
sourcing data from a given web page resource to a corresponding web page item;
populating the corresponding web page item with data sourced from the given web page resource; and
if data in the given web page resource is updated, automatically updating the data populated in the corresponding web page item.

17. The method of claim 13, further comprising:
placing a reference in the web page corresponding to a given web page resource;
if browsing to a data item from the given web page resource is not available, hiding the reference from view in the web page to prevent attempted access to the corresponding given web page resource;
if access to the corresponding given web page resource expires, removing the reference from the web page corresponding to the expired web page resource; and
if a uniform resource locator (URL) for a given web page resource is updated, automatically updating a corresponding URL for the reference to allow access to the given web page resource via the reference placed in the web page corresponding to the given web page resource.

18. A computer-readable medium on which is stored computer-executable instructions which when executed by a computer perform a method of associating web resources with corresponding web page items; comprising:
binding a given web page item in a web page to a given web page resource;
placing a reference in the web page corresponding to the given web page resource;
monitoring the availability of the given web page resource; and
if browsing to a data item from the given web page resource is not available, preventing selection of the reference to prevent attempted access to the given web page resource.

19. The computer-readable medium of claim 18, in response to binding a given web page item to a given web page resource, locking the given web page resource from subsequent access; and allowing access to the locked web page resource via the web page.

20. The computer-readable medium of claim 18, further comprising:
if a uniform resource locator (URL) for a given web page resource is updated, automatically updating a corresponding URL for the reference to allow access to the given web page resource via the reference placed in the web page corresponding to the given web page resource.
